(19) United States
(12) Patent Application Publication
(10) Pub. No.: US 2002/0000221 A1
(43) Pub. Date: Jan. 3, 2002

(54) Device for preheating air in a diesel engine intake line

(76) Inventors: Alois Kilb, Stuttgart (DE); Karl-Heinz Vogel, Backnang Steinbach (DE); Frank Weber, Fellbach (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 09/866,423

(22) Filed: May 25, 2001

(30) Foreign Application Priority Data
May 26, 2000 (DE) 100 26 339.9

(51) Int. Cl. F02G 5/00

(52) U.S. Cl. 123/556

(57) ABSTRACT

In a device for preheating air in an air intake line leading to a Diesel engine in which a heating flange is arranged, the heating flange is switched off and on as required by means of a switching device comprising a semiconductor element as a switching element. At the same time, the state of a battery can be determined by measuring the voltage drop of the battery during such energization of the heating flange.

### BACKGROUND OF THE INVENTION

The invention relates to a device for preheating air in a Diesel engine intake line with a heating flange which is arranged in the intake line and which is electrically energized as required for heating the air. The invention further relates to a method for testing the state of charge of a battery of a Diesel engine.

A device of the type referred to above is disclosed in DE 195 15 533 C2. Such a device with a heating flange is used to heat the air in the intake line leading to a Diesel internal combustion engine prior to, and during, the starting phase. This is particularly necessary for commercial Diesel engines, that is, for Diesel engines of commercial vehicles, since the glow plugs otherwise generally used in Diesel internal combustion engines may not be used in those engines.

Such known devices have proved superior to so-called flame starting systems in which the intake air is heated by means of an open flame for the cold starting of a Diesel internal combustion engine. However, with open flame starting systems, the combustion process taking place inside the Diesel engine is deprived of a large part of the required oxygen as a good part of the oxygen in the intake air is consumed by the preheating flame.

A disadvantage of the known device using a heating flange, however, is that, because of its operating principle wherein the relay switches the heating flange on and off, the known arrangement has a relatively short service life. For this reason, the heating flange for preheating the air in the intake line must only be switched on before starting the Diesel internal combustion engine and must be switched off again after a relatively short time, in order to prevent overheating of the heating element. In the known device, it is not possible to closely control the heat output of the heating flange. This means that in determining this output or the current fed to the heating flange a compromise must be reached between the high output initially required and the limited life of the heating element of the heating flange. This inevitably leads, however, to an inadequate heat output from such known heating flanges during adverse starting conditions.

It is the object of the present invention to provide a device for preheating air in an intake line of a Diesel engine by means of a heating flange, whereby it is possible to control the heat output of the heating flange without damaging or overloading any components.

### SUMMARY OF THE INVENTION

In a device for preheating air in an air intake line leading to a Diesel engine in which a heating flange is arranged, the heating flange is switched off and on as required by means of a switching device comprising a semiconductor switching element. At the same time, the state of a battery can be determined by measuring the voltage drop of the battery during such energization of the heating flange.

Since the switching device is controlled by a semiconductor element, there is no wear so that the heating flange can be switched off and on as often as required and for virtually any periods. Switching may therefore occur at relatively high frequencies, thereby permitting a virtually continuous adjustment of the heat output of the heating flange and hence adaptations to the warm-up conditions of the Diesel engine. In this way, the heating flange need not be switched on continuously. The momentary current flow and hence the maximum heat output of the heating flange therefore can be multiplied many times, which permits a far more rapid temperature increase of the air fed to the Diesel engine, especially during the beginning of intake air preheating. This shortens the preheating time. The output of the heating flange can then easily be reduced by a corresponding control of the on and off switching period, while the current flow remains constant during the energizing periods.

The increased heat output possible according to the invention for example allows Diesel engines to be started at very low outdoor temperatures and at high altitudes, at which such starting was hitherto practically impossible. The fact that, according to the invention, the heating flange can be switched off and on as often as required means that preheating of the air also can be carried out over a longer period than was hitherto usual or possible, since energization of the heating flange can be controlled so as to prevent it from being damaged. In such a case, the on-times are steadily shortened so that they assume an ever-decreasing proportion of time compared to the off-times. This procedure is also highly advantageous in that it results in improved exhaust emission values for the Diesel engine.

In addition, the switching device, controllable by means of a semi-conductor element for switching the heating flange off and on, permits employment of an entirely new method for testing the state of charge of a battery of the Diesel engine, that is of a vehicle using such air preheating device.

According to the invention, the heating flange is switched on by means of the semi-conductor element for a specific period of time, wherein a relatively high current is drawn from the battery. From the drop in the battery voltage, it is then very easy to draw conclusions as to the state of charge of the battery.

Such a procedure was hitherto impossible because of the high load on the switching relay and because of the only very imprecisely defined switching points of a relay. Furthermore, there are no other devices in an internal combustion engine with which a sufficiently large current can be drawn from the battery without at the same time causing negative distortions of the measuring result. A sufficiently accurate measurement has therefore not been possible.

The high current flowing through the heating flange makes it possible to obtain precise determinations concerning the state of charge of the battery using the method according to the invention. Another reason why the state of charge of the battery can be measured by means of the procedure according to the invention is the switching accuracy of such a semiconductor element, which results in a precisely controllable, sometimes very brief, on-time of the heating flange.

Advantageous embodiments and further developments of the invention are apparent from the following description of an exemplary embodiment of the invention on the basis of the accompanying drawings.

### BRIEF DESCRIPTION OF THE DRAWINGS

FIG. 1 shows schematically a Diesel engine with a device according to the invention for preheating air in an intake line;

FIG. 2 is a sectional view of a heating flange according to the invention; and

FIG. 3 shows a control circuit for the heating flange shown in FIG. 2.

### DESCRIPTION OF A PREFERRED EMBODIMENT

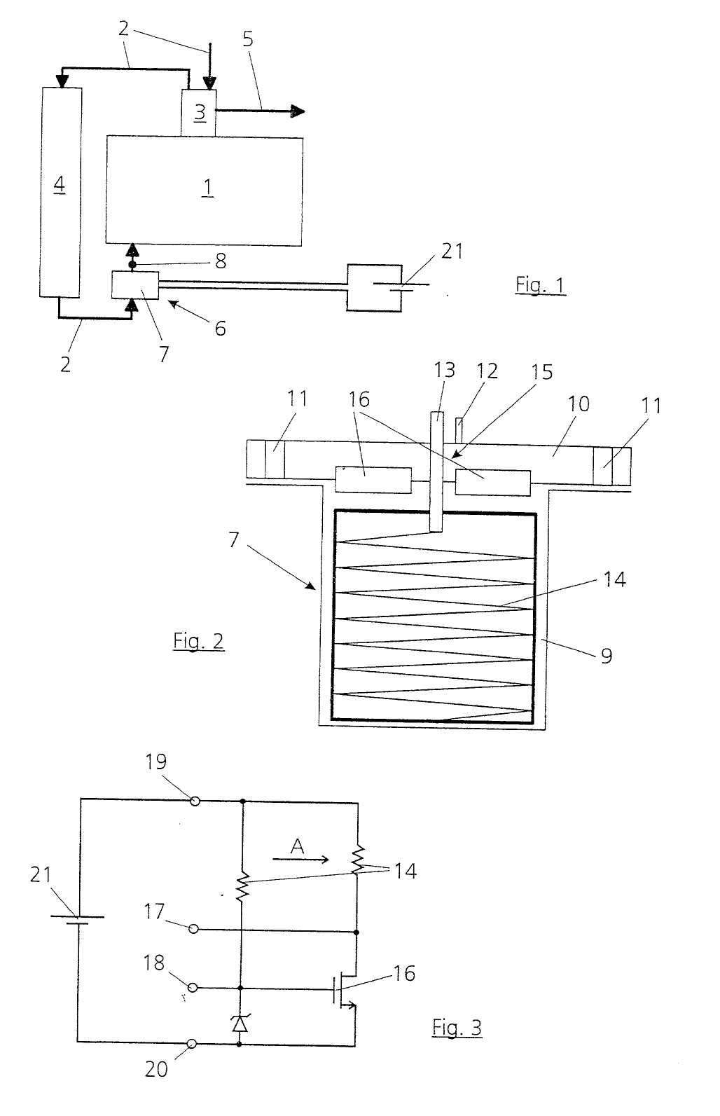

A Diesel internal combustion engine 1 represented in FIG. 1 in extremely schematic form is provided with an intake line 2, which carries fresh air, drawn in by an exhaust turbocharger 3 and conducted through an intercooler 4 to the Diesel engine 1. From the exhaust turbocharger 3, exhaust gas produced by the Diesel engine 1 is discharged by way of an exhaust pipe 5.

The Diesel engine 1 is primarily intended for use in commercial vehicles. It therefore is necessary to heat the air drawn in by way of the intake line 2 before starting of the Diesel engine 1 during difficult outdoor conditions. To facilitate starting, a device 6 is provided, which has a heating flange 7 projecting into the intake line 2, which flange is arranged immediately upstream of the Diesel engine 1. For measuring the air intake temperature, a temperature sensor 8 is provided between the heating flange 7 and an intake manifold, which is not shown but which is directly connected to the Diesel engine 1.

The heating flange 7 is shown in greater detail in FIG. 2.

In a manner known in the art, it has a canister-shaped housing 9 with a cover 10 fitted thereto. The cover 10 is provided with bores 11 for mounting the heating flange 7 to the intake line 2. In addition, there are two electrical connections on the cover 10 leading to the inside of the housing 9, that is a control connection 12 and a electrical power supply connection 13. Electrical current is supplied by way of the power connection 13 serving as a supply lead to an electrical heating element 14. The heating element 14 is arranged inside the housing 9 in a manner known in the art. The heating element 14, in this case, is designed as helical heating filament generating the heat for heating the intake air. The control connection 12 serves to control the on/off switching of the heating flange 7, which is described in greater detail below.

A switching device 15 is provided for switching the heating flange 7 off and on, which device includes the control connection 12 and a semiconductor element 16. When a corresponding pulse is applied to the semiconductor element 16 by way of the control connection 12, the semiconductor element 16 switches the heating element 14 on or off, that is current flow is controlled via the power connection 13. The control connection 12 may, at the same time, be coupled to the temperature sensor 8.

Since the semiconductor element 16 is not subjected to wear of any kind, the heating element 14 of the heating flange 7 can be switched off and on as often as required by means of the switching device 15. In order to regulate the output of the heating element 14, the switching device 15 switches the heating element 14 off and on with a certain frequency. If the on-time is longer than the off-time, this results in a higher output of the heating element 14 over time, so that the air in the intake line 2 can be heated more rapidly, thereby facilitating starting of the Diesel engine 1. It is to be noted that the current flow applied to the heating element 14 remains constant and the heating output is determined solely by the length of time the heating element 14 is switched on. When starting the Diesel engine 1, the heating flange 7 is briefly switched off, in order to make sufficient power available to a starter (not shown). The starting procedure for preheating and starting the Diesel internal combustion engine 1 may be recorded in a characteristic performance graph.

By using a fuse element (not shown) on the input side of the power connection 13, it is possible to prevent overloading of the heating element 14. Since the power supply can be accurately controlled, the heating element 14 can be supplied by way of the power connection 13 with far higher momentary currents than hitherto possible, thereby also generating increased heat output.

FIG. 3 represents a circuit diagram for the heating flange 7, in which a diagnostics input 17 is arranged between the semiconductor element 16 and the two heating elements 14 provided in this case. In addition, a control module 18 known in the art and connected to the temperature sensor 8 is connected to the semiconductor element 16. In FIG. 3, the power connection 13 is represented by a positive pole 19 and a negative pole 20, to which the battery voltage is applied in order to permit a flow of current for heating the heating element 14. In FIG. 3, the direction of flow of the intake air is indicated by the arrow A.

The diagnostics input 17 permits a fault diagnosis for the device 6, that is, for the heating flange 7 and the semiconductor element 16, which diagnosis assigns the following error messages to the signals on the diagnostics input 17 specified below and to the control module 18.

The signals 0 on the diagnostics input 17 and on the control module 18 indicate that no voltage is present; the semiconductor element 16 is defective and/or there is a short-circuit to ground.

A signal 1 on the diagnostics input 17 indicating a voltage is present and the signal 0 on the control module 18 indicate that there is no fault and that the heating flange 7 is switched off.

The signal 0 on the diagnostics input 17 and the signal 1 on the control module 18 indicates that there is no fault, the heating flange 7 is switched on.

The signals 1 on the diagnostics input 17 and on the control module 18 indicate that there is an interruption in the power connection 13 and/or the semiconductor element 16 is defective.

With the arrangement shown in the figures, a new method for testing the state of charge of a battery 21 of the Diesel engine is also available. For testing the battery, it is necessary to switch the heating flange 7 on for a certain period of time by means of the semiconductor element 16 of the switching device 15. Depending on its fixed internal resistance, the heating flange 7 then draws a certain current from the battery 21 and the state of charge of the battery 21 can then be determined by measuring the voltage drop of the battery 21. The method described is very suited for example for use with a vehicle on-board diagnostics system.

The method can be performed because the heating flange 7 or the heating element 14 draws a large current of up to 400 amps and more from the battery 21 that is required for such a measurement and for drawing conclusions from such a measurement. Since, during the operation of the heating element 14, there are no electrical conductors moving in a magnetic field, as is the case for example with a starter, no current is induced that can influence the measuring result.

What is claimed is:

1. A device for preheating air in a Diesel engine air intake line, comprising a heating flange arranged in said intake line and a switching device including semiconductor element for controlling energization of said heating flange by on and of switching of said switching device.

2. A device according to claim 1, wherein said heating flange includes an electric heating element.

3. A device according to claim 2, wherein said electric heating element or a supply lead to said heating element includes a fuse element, which interrupts the current flow to said electric heating element before said heating element becomes overloaded.

4. A device according to claim 1, wherein said heating flange is provided with a diagnostics input connection.

5. A device according to claim 1, wherein a control module is provided to which said semiconductor element is connected for controlling the energization of said heating element.

6. A device according to claim 5, wherein said control module is connected to a temperature sensor for measuring the temperature of the air in said air intake line.

7. A device according to claim 6, wherein said temperature sensor in said air intake line is arranged downstream of said heating flange and upstream of an intake manifold of said Diesel engine.

8. A method for testing the state of charge of a battery of a Diesel engine including an electric heating flange connected to an electric power supply by way of a semiconductor switch for preheating air in an air intake line leading to said Diesel engine, said method comprising the steps of switching on the electric power supply to said heating flange for energization of said heating flange for a specific period of time and measuring the voltage drop of the battery during such energization.
